(19) United States
(12) Patent Application Publication
(10) Pub. No.: US 2025/0029395 A1
(43) Pub. Date: Jan. 23, 2025

(54) METHOD FOR GENERATING SENSOR DATA AND METHOD FOR VEHICLE SIMULATION

(71) Applicant: Robert Bosch GmbH, Stuttgart (DE)

(72) Inventors: Carsten Brickwedde, Stuttgart (DE); Emilie Hincker-Piocelle, Ludwigsburg (DE); Markus Vogelgesang, Benningen Am Neckar (DE); Tobias Mueller, Weil Im Schoenbuch (DE); Vaclav Kocourek, Beilstein (DE)

(21) Appl. No.: 18/761,542

(22) Filed: Jul. 2, 2024

(30) Foreign Application Priority Data
Jul. 18, 2023 (DE) 10 2023 206 788.9

(51) Int. Cl. G06V 20/58; G06V 10/778; G06V 10/82; G06V 20/56

(52) U.S. Cl. CPC G06V 20/582; G06V 10/778; G06V 10/82; G06V 20/588

(57) ABSTRACT

A method for generating sensor data. The method includes providing first sensor measurement data of at least a first vehicle sensor, calculating virtual object data of a virtual vehicle surroundings model that includes a virtual second vehicle sensor, wherein a sensor acquisition range of the first vehicle sensor and a sensor acquisition range of the second vehicle sensor overlap spatially and/or temporally in the vehicle surroundings model, calculating at least second modeled sensor data of the virtual second vehicle sensor using a trained first sensor data algorithm depending on the virtual object data, wherein the first sensor data algorithm is based on a training process using training data that include selective first sensor measurement data of the first vehicle sensor, outputting a sensor data set that at least includes the first sensor measurement data and the second modeled sensor data.

### CROSS REFERENCE

The present application claims the benefit under 35 U.S.C. § 119 of German Patent Application No. DE 10 2023 206 788.9 filed on Jul. 18, 2023, which is expressly incorporated herein by reference in its entirety.

### FIELD

The present invention relates to a method for generating sensor data. The present invention also relates to a method for vehicle simulation.

### BACKGROUND INFORMATION

Vehicle simulations carried out in conventional vehicle-in-the-loop systems use sensor models for vehicle sensors of the vehicle that physically map the respective vehicle sensors in the vehicle model in order to obtain sensor data for the vehicle simulation from the respective sensor models. To simulate a radar sensor, for example, an accurate sensor model that takes into account the physical properties, in particular the emission, reflection and reception of the radar signals, of the radar sensor is used. If multiple vehicle sensors are to be taken into account in the vehicle simulation, an accurate physical sensor model is needed for each individual vehicle sensor.

### SUMMARY

According to the present invention, a method for generating sensor data is provided. This makes it possible to reduce the effort required to create sensor models. The vehicle simulation can be carried out more cost-effectively, more easily and more quickly. The computational effort of the vehicle simulation can be reduced and the sensor data of the vehicle sensors can be provided with the dynamics required in the vehicle simulation. The simulated sensor data can preferably be provided in real time.

The vehicle can be a motor vehicle, in particular a (semi)-autonomous motor vehicle or a two-wheeled vehicle. The vehicle can be a movable robot.

The sensor measurement data can be digital and/or analog sensor signals of the respective vehicle sensor. The modeled sensor data can be data that simulates these sensor signals or components of these sensor data.

The vehicle surroundings model is a virtual representation of a simulated or imaginary surroundings of the vehicle with at least one virtual object. The virtual object can be an object, for example a traffic sign, an uneven road surface, a living creature, a plant, a building or a vehicle in the surroundings of the vehicle.

According to an example embodiment of the present invention, the virtual object data can be data that identify, describe and/or characterize the virtual objects in the vehicle surroundings model. The virtual object data can be limited to the dimensions of the sensor data or it can be higher dimensional. The virtual object data can provide spatial information, distance information and/or reflection properties of at least one virtual object, for example. The virtual object data can be implemented in the sensor signals as characteristics that identify the virtual objects, for example amplitudes.

The sensor acquisition range, also referred to as the field of view (FoV), is understood to be the spatial field of view of the vehicle sensor that can be covered by the respective vehicle sensor. The sensor acquisition range can be a real sensor acquisition range or a virtual sensor acquisition range.

According to an example embodiment of the present invention, the vehicle sensor can be a LiDAR sensor, a radar sensor, a camera, an acceleration sensor or an ultrasonic sensor. The first and second vehicle sensors can be assigned to the same or different sensor modalities. The first vehicle sensor can be a camera, for instance, and the second vehicle sensor can be a radar sensor. It is also possible for the first and second vehicle sensor to be a radar sensor.

According to an example embodiment of the present invention, the virtual first and second vehicle sensors can have sensor acquisition ranges that at least partially overlap spatially and/or temporally. A virtual object can thus be at least partially detectable by both virtual vehicle sensors.

According to an example embodiment of the present invention, in addition to the second modeled sensor data, the sensor data set can also include third modeled sensor data of a virtual third vehicle sensor. Further modeled sensor data from further virtual vehicle sensors can be formed as well and added to the sensor data set. The vehicle surroundings model can include a virtual third or further vehicle sensor for this purpose. The third and further modeled sensor data can be calculated in the same way as the calculation of the second modeled sensor data described above.

The training process of the first sensor data algorithm can be based on machine learning. The training data can be used in the training process for machine learning. Machine learning can include supervised learning, unsupervised learning, semi-supervised learning, reinforcement learning, transfer learning and/or evolutionary algorithms. The training data includes both the input information and the expected output values.

In a preferred example embodiment of the present invention, it is advantageous if the second modeled sensor data are calculated as input data of the first sensor data algorithm depending on first modeled sensor data of a virtual first vehicle sensor that maps the first vehicle sensor in the vehicle surroundings model calculated from the virtual object data. The first modeled sensor data can be calculated depending on the virtual object data using a physical sensor model assigned to the first vehicle sensor. This physical sensor model of the first vehicle sensor can be the only physical sensor model used to generate the first and second modeled, preferably all of the modeled, sensor data.

In a specific example embodiment of the present invention, it is advantageous if the first sensor measurement data are enriched with the first modeled sensor data and the sensor data set comprises this enriched first sensor measurement data. This makes it possible for the surroundings information to be more comprehensive. The sensor data set can comprise only the first sensor measurement data as the sensor measurement data when second and third sensor measurement data are unnecessary.

In a preferred example embodiment of the present invention, it is advantageous if the second modeled sensor data are calculated directly as input data of the first sensor data algorithm depending on the virtual object data. There is therefore no need to use a physical sensor model.

In a specific example embodiment of the present invention, it is advantageous if the selective first sensor measurement data are selectively formed from the components of the first sensor measurement data assigned to at least one object in the sensor acquisition range of the first vehicle sensor. The selective first sensor measurement data can correspond to the components of the first sensor measurement data that characterize the at least one object, or can emerge from said components, in particular by filtering and/or subsequent processing.

In a preferred example embodiment of the present invention, it is provided that the training process involves training the first sensor data algorithm directly with the training data comprising the selective first sensor measurement data. The first sensor data algorithm can include a neural network the parameters of which have been learned depending on the training data. The parameters can have been learned using deep learning. The first sensor data algorithm can have been learned using supervised learning, unsupervised learning, semi-supervised learning, reinforcement learning, transfer learning or using evolutionary algorithms.

In a special example configuration of the present invention, it is advantageous if the training process involves indirectly training the first sensor data algorithm with the training data comprising the selective first sensor measurement data, wherein the selective first sensor measurement data form training data of an upstream sensor data algorithm which, when used in the training process, in turn generates further virtual sensor data depending on the virtual object data of the virtual vehicle surroundings model that then form the training data of the first sensor data algorithm. The upstream sensor data algorithm can include a neural network the parameters of which have been learned depending on the training data of the upstream sensor data algorithm. The parameters can have been learned using deep learning. The upstream sensor data algorithm can have been learned using supervised learning, unsupervised learning, semi-supervised learning, reinforcement learning, transfer learning or using evolutionary algorithms.

An advantageous preferred example embodiment of the present invention is one in which the second modeled sensor data of the training data were calculated using a trained upstream sensor data algorithm. The upstream sensor data algorithm can include a neural network the parameters of which have been learned. The parameters can have been learned using deep learning. The upstream sensor data algorithm can have been learned using supervised learning, unsupervised learning, semi-supervised learning, reinforcement learning, transfer learning or using evolutionary algorithms.

In a specific example embodiment of the present invention, it is advantageous if the input data of the upstream sensor data algorithm, when used in the training process, comprise first modeled sensor data of a virtual first vehicle sensor that maps the first vehicle sensor in the vehicle surroundings model calculated from the virtual object data.

In a specific example embodiment of the present invention, it is advantageous if the training data of the first sensor data algorithm directly comprise the virtual object data.

According to the present invention, a method for vehicle simulation is provided as well. The vehicle dynamics can include vehicle kinematics. The vehicle dynamics can be a vehicle movement, in particular a vehicle speed, a vehicle acceleration, in at least one direction. The vehicle simulation can also be a real vehicle operation in which the sensor data are enriched with virtual sensor data.

Further advantages and advantageous example embodiments of the present invention will emerge from the description of the figures and the figures.

### BRIEF DESCRIPTION OF THE DRAWINGS

The present invention is described in detail in the following with reference to the figures.

FIG. 1 shows a method for generating sensor data in a specific example embodiment of the present invention.

FIG. 2 shows a method for generating sensor data in a further specific example embodiment of the present invention.

FIG. 3 shows a method for generating sensor data in a further specific example embodiment of the present invention.

FIG. 4 shows a method for vehicle simulation in a specific embodiment of the present invention.

### DETAILED DESCRIPTION OF EXAMPLE EMBODIMENTS

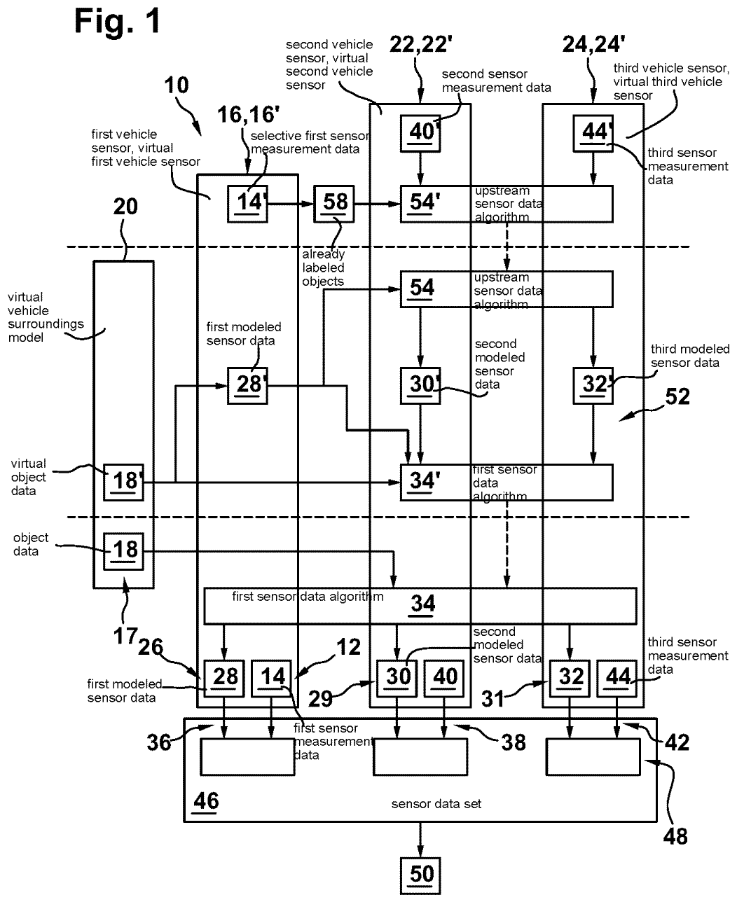

FIG. 1 shows a method for generating sensor data in a specific embodiment of the present invention. The method 10 for generating sensor data includes providing 12 first sensor measurement data 14 of at least a first vehicle sensor 16 and calculating 17 virtual object data 18 of a virtual vehicle surroundings model 20. The virtual object data 18 indicate virtual objects in the virtual surroundings of the vehicle.

The virtual vehicle surroundings model 20 includes a virtual second vehicle sensor 22′ and a virtual third vehicle sensor 24′, wherein a sensor acquisition range of the first vehicle sensor 16, a sensor acquisition range of the second vehicle sensor 22′ and a sensor acquisition range of the third vehicle sensor 24′ overlap spatially and/or temporally in the vehicle surroundings model 20.

There is also a calculation 26 of first modeled sensor data 28 of a virtual first vehicle sensor 16′ that maps the first vehicle sensor 16 in the virtual vehicle surroundings model 20, a calculation 29 of second modeled sensor data 30 of the virtual second vehicle sensor 22′ and a calculation 31 of third modeled sensor data 32 of the virtual third vehicle sensor 24′ using a trained first sensor data algorithm 34, in each case depending on the virtual object data 18, directly as input data of the first sensor data algorithm 34.

The first sensor measurement data 14 of the first vehicle sensor 16 are supplemented with an enrichment 36 with the first modeled sensor data 28. Second sensor measurement data 40 of the second vehicle sensor 22 that actually corresponds to the virtual second vehicle sensor 22′ is moreover supplemented with an enrichment 38 with the second modeled sensor data 30 and third sensor measurement data 44 of a third vehicle sensor 24 that actually corresponds to the virtual third vehicle sensor 24′ is supplemented with an enrichment 42, and a sensor data set 46 comprising these enriched sensor measurement data 48 is generated.

It is also possible that the second and third sensor measurement data 40, 44 are omitted from the sensor data set 46, and the sensor data set 46 then has only the second and third modeled sensor data 30, 32 from the second and third vehicle sensor 22, 24 or the virtual second and third vehicle sensor 22′, 24′.

It is also possible that, with respect to the first vehicle sensor 16, the sensor data set 46 comprises only the first sensor measurement data 14 without the first modeled sensor data 28.

The sensor data set 46 can be output to a subsequent sensor data processing 50 of a vehicle simulation.

The first sensor data algorithm 34 is based on a training process 52 using training data that include the selective first sensor measurement data 14′ of the first vehicle sensor 16. The trained first sensor data algorithm 34 is trained with training data, wherein the training data comprises first modeled sensor data 28′ of the virtual first vehicle sensor 16′, second modeled sensor data 30′ of the virtual second vehicle sensor 22′ and third modeled sensor data 32′ of the virtual third vehicle sensor 24′, calculated from virtual object data 18′ of the vehicle surroundings model 20. The training process 52 of the first sensor data algorithm 34′ takes place before the method 10 for generating sensor data is carried out.

The second and third modeled sensor data 30′, 32′ of the training data are in turn calculated using a trained upstream sensor data algorithm 54, with the first modeled sensor data 28′ of the virtual first vehicle sensor 16′ as input data. The upstream sensor data algorithm 54′ is learned in advance with training data formed from the selective first sensor measurement data 14′ of the first vehicle sensor 16, second sensor measurement data 40′ of the second vehicle sensor 22, third sensor measurement data 44′ of the third vehicle sensor 24 and the virtual object data 18′.

The training process 52 of the first sensor data algorithm 34 thus includes indirectly training the first sensor data algorithm 34′ with the training data comprising the selective first sensor measurement data 14′, wherein the selective first sensor measurement data 14′ form training data of the upstream sensor data algorithm 54′, wherein, when used in the training process 52, the upstream sensor data algorithm 54 in turn generates further virtual sensor data, here the second and third modeled sensor data 20′, 32′, depending on virtual object data 18′ of the virtual vehicle surroundings model 20 which then form the training data of the first sensor data algorithm 34′. When used in the training process 52, the input data of the upstream sensor data algorithm 54 include first modeled sensor data 28′ of the virtual first vehicle sensor 16′ calculated from the virtual object data 18′.

The selective first sensor measurement data 14′ are preferably limited to already-labeled objects 58 of the surroundings of the vehicle and are therefore available as labeled data. The selective first sensor measurement data 14′ are in particular selectively formed from the components of the first sensor measurement data 14 assigned to at least one object in the sensor acquisition range of the first vehicle sensor 16.

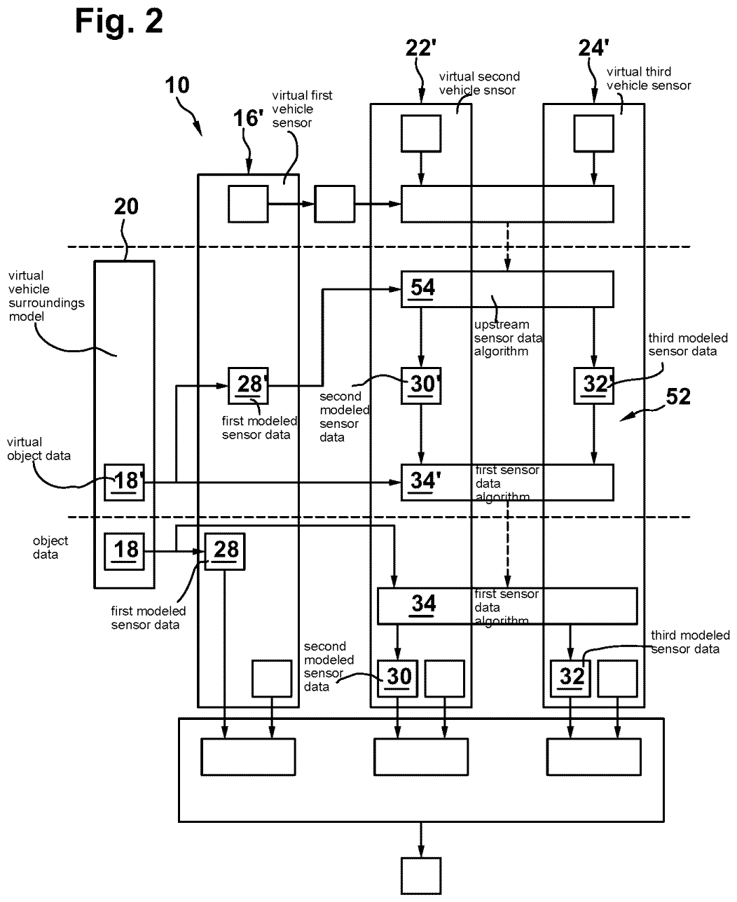

FIG. 2 shows a method for generating sensor data in a further specific embodiment of the present invention. The method 10 for generating sensor data is similar to that of FIG. 1 except for the following differences. The first sensor data algorithm 34 calculates the second and third modeled sensor data 30, 32 using the virtual object data 18 as input data, while the first modeled sensor data 28 are calculated directly from the virtual object data 18. The first modeled sensor data 28′ are therefore likewise excluded from the training data of the first sensor data algorithm 34′.

The first modeled sensor data 28 are calculated from the virtual object data 18. The calculation is thus carried out in parallel to the calculation of the second and third modeled sensor data 30, 32 using the first sensor data algorithm 34.

The first sensor data algorithm 34′ was trained in the training process 52 with training data comprising virtual object data 18′ of the vehicle surroundings model 20, second modeled sensor data 30′ of the virtual second vehicle sensor 22′ and third modeled sensor data 32′ of the virtual third vehicle sensor 24′. This training process 52 of the first sensor data algorithm 34′ takes place before the method 10 for generating sensor data is carried out.

The second and third modeled sensor data 30′, 32′ of the training data are in turn calculated using a trained upstream sensor data algorithm 54, with the first modeled sensor data 28′ of the virtual first vehicle sensor 16′ as input data. Otherwise, the shown unlabeled symbols correspond to those of FIG. 1.

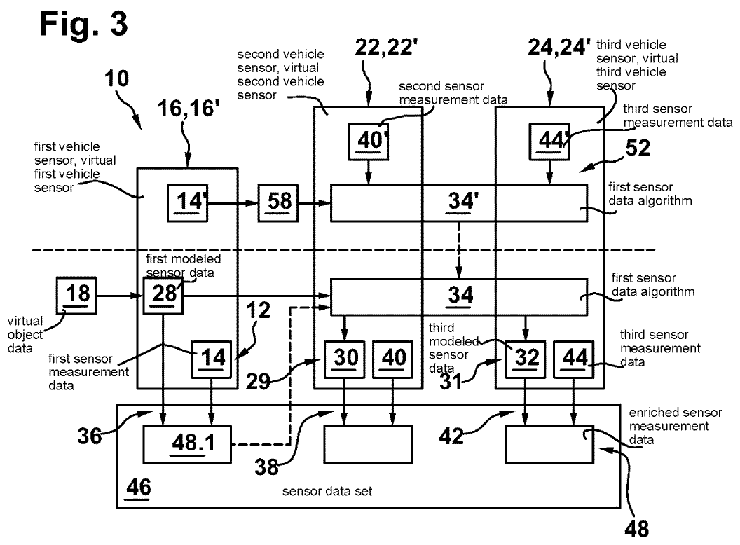

FIG. 3 shows a method for generating sensor data in a further specific embodiment of the present invention. The method 10 for generating sensor data includes providing 12 first sensor measurement data 14 of at least the first vehicle sensor 16, calculating first modeled sensor data 28 of the virtual first vehicle sensor 16′ from the virtual object data 18 and calculating 29 second modeled sensor data 30 of the virtual second vehicle sensor 22′ and calculating 31 third modeled sensor data 32 of the virtual third vehicle sensor 24′ using the learned first sensor data algorithm 34, in each case depending on the first modeled sensor data 28 calculated from the virtual object data 18 as input data.

Enriching 36 the first sensor measurement data 14 with the first modeled sensor data 28, enriching 38 second sensor measurement data 40 with the second modeled sensor data 30 and enriching 42 third sensor measurement data 44 with the third modeled sensor data 32 generates a sensor data set 46 comprising these enriched sensor measurement data 48. It is also possible that the second and third measurement data 40, 44 are omitted from the sensor data set 46, and the sensor data set 46 then has only the second and third modeled sensor data 30, 32 from the second and third vehicle sensor 22, 24.

The first sensor data algorithm 34′ is trained using a training process 52 which involves training the first sensor data algorithm 34′ directly with the training data comprising the selective first sensor measurement data 14′, the second sensor measurement data 40′ of the second vehicle sensor 22, and the third sensor measurement data 44′ of the third vehicle sensor 24. The training process 52 takes place before the method 10 for generating sensor data is carried out. The selective first sensor measurement data 14′ preferably includes already-labeled objects 58 of the surroundings of the vehicle and are therefore available as labeled data.

Alternatively, as shown here with a dashed connecting arrow, there may also be an embodiment in which the enriched first sensor measurement data 48.1 are used as input data of the first sensor data algorithm 34 instead of the first modeled sensor data 28. In this particular embodiment, the sensor data set 46 can then comprise only the first sensor measurement data 14 as the sensor measurement data when the second and third sensor measurement data 40, 44 are unnecessary. The sensor data set 46 can thus include the enriched first sensor measurement data 14, as well as the second and third modeled sensor data 30, 32.

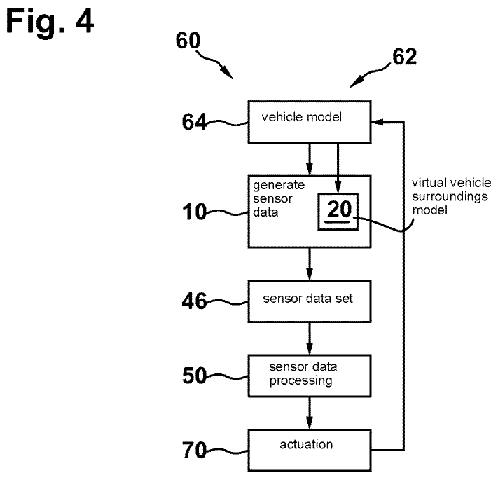

FIG. 4 shows a method for vehicle simulation in a specific embodiment of the present invention. The vehicle simulation 60 takes place in a vehicle-in-the-loop application and includes providing 62 a vehicle model 64 for simulating the vehicle dynamics of a vehicle. The sensor data set 46 generated using a method 10 for generating sensor data described above, in particular in FIG. 1, is processed with a sensor data processing 50. At least one vehicle actuator assigned to the vehicle model 64 is actuated 70 depending on the sensor data processing 50. The actuation 70 of the vehicle actuator in turn affects the vehicle dynamics, the change of which is taken into account in the vehicle model 64 and in the surroundings model 20.

What is claimed is:

1. A method for generating sensor data, comprising the following steps:
providing first sensor measurement data of at least a first vehicle sensor;
calculating virtual object data of a virtual vehicle surroundings model that includes a virtual second vehicle sensor, wherein a sensor acquisition range of the first vehicle sensor and a sensor acquisition range of the virtual second vehicle sensor overlap spatially and/or temporally in the vehicle surroundings model;
calculating at least second modeled sensor data of the virtual second vehicle sensor using a trained first sensor data algorithm depending on the virtual object data, wherein the first sensor data algorithm is based on a training process using training data that include selective first sensor measurement data of the first vehicle sensor; and
outputting a sensor data set that at least includes the first sensor measurement data and the second modeled sensor data.

2. The method for generating sensor data according to claim 1, wherein the second modeled sensor data are calculated as input data of the first sensor data algorithm depending on first modeled sensor data of a virtual first vehicle sensor that maps the first vehicle sensor in the vehicle surroundings model calculated from the virtual object data.

3. The method for generating sensor data according to claim 2, wherein the first sensor measurement data are enriched with the first modeled sensor data, and the sensor data set includes the enriched first sensor measurement data.

4. The method for generating sensor data according to claim 1, wherein the second modeled sensor data are calculated directly as input data of the first sensor data algorithm depending on the virtual object data.

5. The method for generating sensor data according to claim 1, wherein the selective first sensor measurement data are selectively formed from components of the first sensor measurement data assigned to at least one object in the sensor acquisition range of the first vehicle sensor.

6. The method for generating sensor data according to claim 1, wherein the training process involves training the first sensor data algorithm directly with the training data including the selective first sensor measurement data.

7. The method for generating sensor data according to claim 1, wherein the training process involves indirectly training the first sensor data algorithm with the training data including the selective first sensor measurement data, wherein the selective first sensor measurement data form training data of an upstream sensor data algorithm which, when used in the training process, in turn generates further virtual sensor data depending on the virtual object data of the virtual vehicle surroundings model that then form the training data of the first sensor data algorithm.

8. The method for generating sensor data according to claim 7, wherein, when used in the training process, the input data of the upstream sensor data algorithm include first modeled sensor data of a virtual first vehicle sensor that maps the first vehicle sensor in the vehicle surroundings model calculated from the virtual object data.

9. The method for generating sensor data according to claim 7, wherein the training data of the first sensor data algorithm directly includes the virtual object data.

10. A method for vehicle simulation, comprising the following steps:
providing a vehicle model for simulating the vehicle dynamics of a vehicle;
sensor data processing including processing a sensor data set generated by:
providing first sensor measurement data of at least a first vehicle sensor,
calculating virtual object data of a virtual vehicle surroundings model that includes a virtual second vehicle sensor, wherein a sensor acquisition range of the first vehicle sensor and a sensor acquisition range of the virtual second vehicle sensor overlap spatially and/or temporally in the vehicle surroundings model,
calculating at least second modeled sensor data of the virtual second vehicle sensor using a trained first sensor data algorithm depending on the virtual object data, wherein the first sensor data algorithm is based on a training process using training data that include selective first sensor measurement data of the first vehicle sensor, and
outputting the sensor data set that at least includes the first sensor measurement data and the second modeled sensor data; and
actuating at least one simulated vehicle actuator assigned to the vehicle model depending on the sensor data processing.
